(19) United States
(12) Patent Application Publication
(10) Pub. No.: US 2010/0303172 A1
(43) Pub. Date: Dec. 2, 2010

(54) METHODS AND TECHNIQUES FOR 3G CELLULAR TRANSMITTERS

(75) Inventors: Alireza Zolfaghari, Irvine, CA (US); Hooman Darabi, Irvine, CA (US); Ahmad Mirzaei, Los Angeles, CA (US)

Correspondence Address: GARLICK HARRISON & MARKISON, P.O. BOX 160727, AUSTIN, TX, 78716-0727, US

(73) Assignee: BROADCOM CORPORATION, Irvine, CA (US)

(21) Appl. No.: 12/473,571

(22) Filed: May 28, 2009

(51) Int. Cl. H04L 27/20; H04L 27/00

(52) U.S. Cl. 375/308; 375/295

(57) ABSTRACT

A transmitter operates in different modulation modes to support both GSM/EDGE and WCDMA cellular telephony applications. The transmitter modulates an outgoing signal to produce a complex modulated signal in a first modulation mode and a constant or variable envelope modulated signal in a second modulation mode. A local oscillation generator and mixer operate to up-convert the complex modulated signal to produce a modulated RF signal in the first modulation mode and to up-convert the phase component of the constant or variable envelope modulated signal to an RF phase signal and mix the RF phase signal with the envelope component thereof to produce the modulated RF signal in the second modulation mode.

### BACKGROUND

1. Technical Field

The present invention relates to wireless communications and, more particularly, to transmitters in wireless communication systems.

2. Related Art

Modern wireless RF transmitters for applications, such as cellular, personal, and satellite communications, employ digital modulation schemes such as frequency shift keying (FSK) and phase shift keying (PSK), and variants thereof, often in combination with code division multiple access (CDMA) communication. Independent of the particular communications scheme employed, the RF transmitter output signal, s_{RF}(t), can be represented mathematically as

s_{RF}(t)=r(t)cos(2πf_{c}t+θ(t)) (1)

where f_{c} denotes the RF carrier frequency, and the signal components r(t) and θ(t) are referred to as the envelope and phase of s_{RF}(t), respectively.

Some of the above mentioned communication schemes have constant envelope, i,e.,

r(t)=R,

and these are thus referred to as constant-envelope communications schemes. In these communications schemes, θ(t) constitutes all of the information bearing part of the transmitted signal. Other communications schemes have envelopes that vary with time and these are thus referred to as variable-envelope communications schemes. In these communications schemes, both r(t) and θ(t) constitute information bearing parts of the transmitted signal.

The most widespread standard in cellular wireless communications is currently the Global System for Mobile Communications (GSM). A second generation GSM standard employs Gaussian Minimum Shift Keying (GMSK), which is a constant-envelope binary modulation scheme allowing raw transmission at a maximum rate of 270.83 kilobits per second (kbps). While GSM is sufficient for standard voice services, future high-fidelity audio and data services demand higher data throughput rates.

Higher data rates can be achieved in the specification of the Enhanced Data rates for GSM Evolution (EDGE) cellular telephony standard by selectively applying a 3π/8 offset, 8-level PSK (8-PSK) modulation scheme. With this variable-envelope communication scheme, the maximum bit rate is tripled compared to GSM, while the chosen pulse shaping ensures that the RF carrier bandwidth is the same as that of GSM, allowing for the reuse of the GSM signal bandwidths.

In addition, WCDMA (Wideband Code Division Multiple Access) is the world's leading third generation (3G) technology. With data rates up to 100 times those of today's networks, WCDMA will introduce a new generation of telecommunication into the world and change the way people communicate forever. Providing mobile users with data rates initially up to 384 kbps, and in later releases, up to 14 Mbps, WCDMA is an ultra high-speed, ultra high-capacity radio technology that generates and carries a new range of rich, fast, colorful media that consumers will be able to access over their mobiles (e.g., color graphics, video, digital audio, Internet and e-mail). Occupying an RF channel bandwidth of 5 MHz, WCDMA employs a “spreading sequence” with a chip rate of 3.84 million chips per second (Mcps) and a 4-level PSK, variable-envelope modulation scheme.

It is important to ensure that WCDMA, while operating in different frequency bands and larger bandwidth, is seen as an evolution of the GSM networks. This ensures that investments made in GSM networks will remain profitable for years to come while introducing the support of WCDMA service. The long-term goal is to have a seamless network solution with multi-mode handsets that work on both GSM and WCDMA frequencies, and a network that combines the GSM and WCDMA resources. In the seamless network solution, services are provided over GSM or WCDMA radio access, depending upon radio source availability and service demand, without any input or knowledge of users. Thus, there is a need for a transmitter architecture that is capable of operating in different modulation modes to support both WCDMA and EDGE/GSM.

### SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

A better understanding of the present invention can be obtained when the following detailed description of the preferred embodiment is considered with the following drawings, in which:

FIG. 1 is a functional block diagram illustrating a communication system that includes a plurality of base stations or access points (APs), a plurality of wireless communication devices and a network hardware component;

FIG. 2 is a schematic block diagram illustrating a wireless communication device as a host device and an associated radio;

FIG. 3 is a schematic block diagram of a multi-mode transmitter architecture supporting GSM/EDGE and WCDMA cellular telephony applications;

FIG. 4 is a schematic block diagram of local oscillator generator for use in the multi-mode transmitter architecture;

FIG. 5 is a schematic block diagram of a multi-mode transmitter architecture supporting high band and low band GSM/EDGE and WCDMA cellular telephony applications;

FIG. 6 is a schematic block diagram of a mixer capable of operating in multiple modes;

FIG. 7 is a schematic block diagram of a differential mixer operating in a GSM/EDGE mode;

FIG. 8 is a schematic block diagram of a differential mixer operating in a WCDMA mode;

FIG. 9 is a diagram illustrating a linearized model of a multi-mode mixer; and

FIG. 10 is a flow chart illustrating one method of the present invention for operating in different modulation modes.

### DETAILED DESCRIPTION OF THE DRAWINGS

In order to support both EDGE/GSM and WCDMA cellular telephony applications, a transmitter architecture is described herein that is capable of operating in different modulation modes. For example, in the WCDMA mode, the transmitter architecture utilizes a Phase Shift Keying (PSK) modulation scheme, while in the EDGE mode, the transmitter architecture utilizes an 8-level PSK (8-PSK) modulation scheme, both of which are variable envelope modulation scheme. For the GSM mode, the transmitter architecture employs Gaussian Minimum Shift Keying (GMSK), which is a constant-envelope modulation scheme. In addition, the methods and techniques described herein can substantially reduce the transmitter area and can be configured to support both separate and multi-mode power amplifiers.

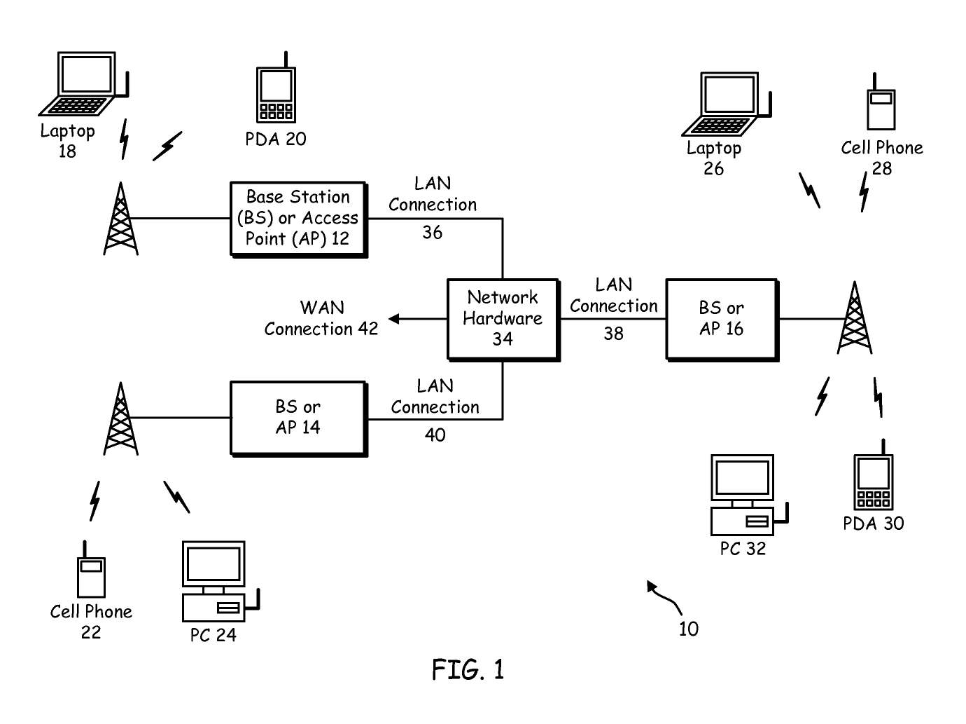

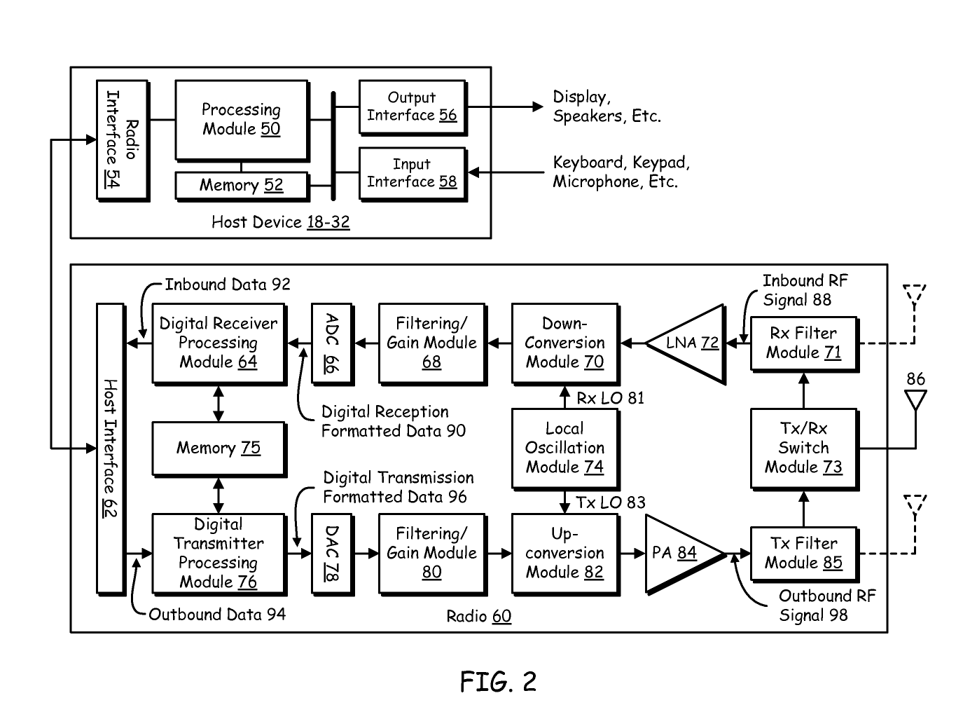

Turning now to FIG. 1, there is illustrated a communication system 10 that includes a plurality of base stations or access points (APs) 12-16, a plurality of wireless communication devices 18-32 and a network hardware component 34. The wireless communication devices 18-32 may be laptop computers 18 and 26, personal digital assistants 20 and 30, personal computers 24 and 32 and/or cellular telephones 22 and 28. The details of the wireless communication devices will be described in greater detail with reference to FIGS. 2-9.

The base stations or APs 12-16 are coupled to the network hardware component 34 via local area network (LAN) connections 36, 38 and 40. The network hardware component 34, which may be a router, switch, bridge, modem, system controller, etc., provides a wide area network connection 42 for the communication system 10. Each of the base stations or access points 12-16 has an associated antenna or antenna array to communicate with the wireless communication devices in its area. Typically, the wireless communication devices 18-32 register with the particular base station or access points 12-16 to receive services from the communication system 10. For direct connections (i.e., point-to-point communications), wireless communication devices communicate directly via an allocated channel.

Typically, base stations are used for cellular telephone systems, while access points are used for in-home or in-building wireless networks. For example, access points are typically used in Bluetooth systems. Regardless of the particular type of communication system, each wireless communication device and each of the base stations or access points includes a built-in radio and/or is coupled to a radio. The radio includes a transceiver (transmitter and receiver) for modulating/demodulating information (data or speech) bits into a format that comports with the type of communication system.

FIG. 2 is a schematic block diagram illustrating a wireless communication device 18-32 as a host device and an associated radio 60. For cellular telephone hosts, the radio 60 is a built-in component. For personal digital assistants hosts, laptop hosts, and/or personal computer hosts, the radio 60 may be built-in or an externally coupled component.

As illustrated, the host wireless communication device 18-32 includes a processing module 50, a memory 52, a radio interface 54, an input interface 58 and an output interface 56. The processing module 50 and memory 52 execute the corresponding instructions that are typically done by the host device. For example, for a cellular telephone host device, the processing module 50 performs the corresponding communication functions in accordance with a particular cellular telephone standard.

The radio interface 54 allows data to be received from and sent to the radio 60. For data received from the radio 60 (e.g., inbound data), the radio interface 54 provides the data to the processing module 50 for further processing and/or routing to the output interface 56. The output interface 56 provides connectivity to an output device, such as a display, monitor, speakers, etc., such that the received data may be displayed. The radio interface 54 also provides data from the processing module 50 to the radio 60. The processing module 50 may receive the outbound data from an input device, such as a keyboard, keypad, microphone, etc., via the input interface 58 or generate the data itself. For data received via the input interface 58, the processing module 50 may perform a corresponding host function on the data and/or route it to the radio 60 via the radio interface 54.

Radio 60 includes a host interface 62, a digital receiver processing module 64, an analog-to-digital converter 66, a filtering/gain module 68, a down-conversion module 70, a low noise amplifier 72, a receiver filter module 71, a transmitter/receiver (TX/RX) switch module 73, a local oscillation module 74, a memory 75, a digital transmitter processing module 76, a digital-to-analog converter 78, a filtering/gain module 80, an IF mixing up-conversion module 82, a power amplifier 84, a transmitter filter module 85, and an antenna 86. The antenna 86 is shared by the transmit and receive paths as regulated by the TX/RX switch module 73. However, in other embodiments, separate antennas can be used for the transmit and receive paths. The antenna implementation will depend on the particular standard(s) to which the wireless communication device is compliant.

The digital receiver processing module 64 and the digital transmitter processing module 76, in combination with operational instructions stored in memory 75, execute digital receiver functions and digital transmitter functions, respectively. The digital receiver functions include, but are not limited to, demodulation, constellation demapping, decoding, and/or descrambling. The digital transmitter functions include, but are not limited to, scrambling, encoding, constellation mapping, and/or modulation.

The digital receiver and transmitter processing modules 64 and 76, respectively, may be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions.

Memory 75 may be a single memory device or a plurality of memory devices. Such a memory device may be a read-only memory, random access memory, volatile memory, non-volatile memory, static memory, dynamic memory, flash memory, and/or any device that stores digital information. Note that when the digital receiver processing module 64 and/or the digital transmitter processing module 76 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. Memory 75 stores, and the digital receiver processing module 64 and/or the digital transmitter processing module 76 executes, operational instructions corresponding to at least some of the functions illustrated herein.

In operation, the radio 60 receives outbound data 94 from the host wireless communication device 18-32 via the host interface 62. The host interface 62 routes the outbound data 94 to the digital transmitter processing module 76, which processes the outbound data 94 in accordance with a particular wireless communication standard (e.g., GSM, EDGE, WCDMA, etc.) to produce digital transmission formatted data 96. The digital transmission formatted data 96 produced by a digital modulator of the present invention will be a digital baseband signal or a digital low IF signal, where the low IF typically will be in the frequency range of 100 KHz to a few Megahertz.

The digital-to-analog converter 78 converts the digital transmission formatted data 96 from the digital domain to the analog domain. The filtering/gain module 80 filters and/or adjusts the gain of the analog baseband signal prior to providing it to the up-conversion module 82. The up-conversion module 82 directly converts the analog baseband signal, or low IF signal, into an RF signal based on a transmitter local oscillation 83 provided by local oscillation module 74. The power amplifier 84 amplifies the RF signal to produce an outbound RF signal 98, which is filtered by the transmitter filter module 85. The antenna 86 transmits the outbound RF signal 98 to a targeted device, such as a base station, an access point and/or another wireless communication device.

The radio 60 also receives an inbound RF signal 88 via the antenna 86, which was transmitted by a base station, an access point, or another wireless communication device. The antenna 86 provides the inbound RF signal 88 to the receiver filter module 71 via the TX/RX switch module 73, where the RX filter module 71 bandpass filters the inbound RF signal 88. The RX filter module 71 provides the filtered RF signal to low noise amplifier 72, which amplifies the inbound RF signal 88 to produce an amplified inbound RF signal. The low noise amplifier 72 provides the amplified inbound RF signal to the down-conversion module 70, which directly converts the amplified inbound RF signal into an inbound low IF signal or baseband signal based on a receiver local oscillation signal 81 provided by local oscillation module 74. The down-conversion module 70 provides the inbound low IF signal or baseband signal to the filtering/gain module 68. The filtering/gain module 68 may be implemented in accordance with the teachings of the present invention to filter and/or attenuate the inbound low IF signal or the inbound baseband signal to produce a filtered inbound signal.

The analog-to-digital converter 66 converts the filtered inbound signal from the analog domain to the digital domain to produce digital reception formatted data 90. The digital receiver processing module 64 decodes, descrambles, demaps, and/or demodulates the digital reception formatted data 90 to recapture inbound data 92 in accordance with the particular wireless communication standard being implemented by radio 60. The host interface 62 provides the recaptured inbound data 92 to the host wireless communication device 18-32 via the radio interface 54.

As one of average skill in the art will appreciate, the wireless communication device of FIG. 2 may be implemented using one or more integrated circuits. For example, the host device may be implemented on a first integrated circuit, while the digital receiver processing module 64, the digital transmitter processing module 76 and memory 75 are implemented on a second integrated circuit, and the remaining components of the radio 60, less the antenna 86, may be implemented on a third integrated circuit. As an alternate example, the radio 60 may be implemented on a single integrated circuit. As yet another example, the processing module 50 of host device 18-32 and the digital receiver processing module 64 and the digital transmitter processing module 76 of radio 60 may be a common processing device implemented on a single integrated circuit. Further, memory 52 and memory 75 may be implemented on a single integrated circuit and/or on the same integrated circuit as the common processing modules of processing module 50, the digital receiver processing module 64, and the digital transmitter processing module 76.

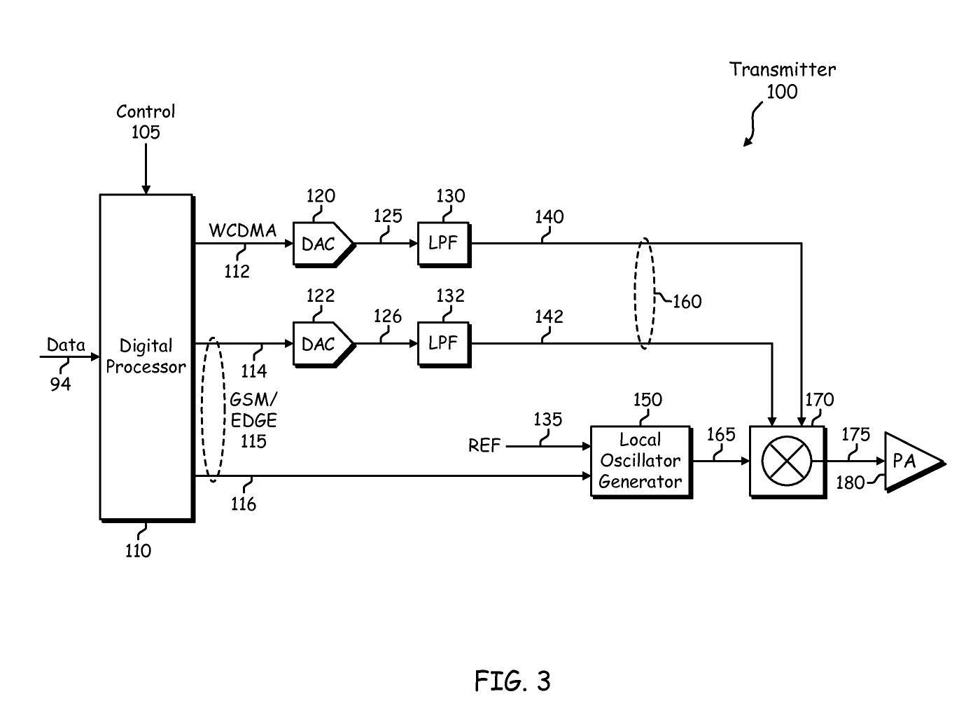

FIG. 3 is a schematic block diagram of an RF transmitter 100 capable of operating in multiple modes. The RF transmitter of FIG. 3 is functionally equivalent to blocks 76, 78, 80, 82 and 84 of FIG. 2. In FIG. 3, it is assumed that a baseband processor delivers a baseband signal containing outbound data 94 to the radio transmitter 100 for further processing and RF transmission. The transmitter 100 shown in FIG. 3 includes a digital processor (DP) 110, digital-to-analog converters (DACs) 120 and 122, low pass filters (LPFs) 130 and 132, a local oscillator generator 150, a multi-mode mixer 170 and a power amplifier (PA) 180. The multi-mode mixer 170 is operable to drive the PA 180 without the need for a separate power amplifier driver in both WCDMA and GSM/EDGE modes.

The digital processor (DP) 110 performs the necessary pulse shaping, modulation, and interpolation filtering. In addition, the digital processor 110 is capable of using different modulation schemes (e.g., PSK or GMSK), depending on a modulation type indicated by a control signal 105. The output of the digital processor 110 is provided along one or more paths, depending on the modulation type. For example, as shown in FIG. 3, a first path is coupled to receive a WCDMA digital signal 112, whereas second and third paths are coupled to receive a GSM/EDGE digital signal 115. More particularly, the second path is coupled to receive a digital envelope signal 114 of the GSM/EDGE digital signal 115, while the third path is coupled to receive a digital phase signal 116 of the GSM/EDGE digital signal 115.

For example, when operating in GSM mode, as the outgoing digital data 94 enters the digital processor 110, the control signal 105 instructs the digital processor 110 to perform pulse shaping and modulation on the outgoing digital data 94 to produce a constant envelope modulated digital signal. As described above, the GSM standard employs Gaussian Minimum Shift Keying (GMSK), which is a constant-envelope binary modulation scheme. Therefore, the envelope path at the output of the digital processor 110 is not activated to ensure that no dynamic signal is transmitted on the envelope path. As an example, in one embodiment, the digital envelope signal 114 is set to a constant value of one. Thus, in GSM mode, the digital processor 110 modulates the outgoing digital data 94 along the phase path only, and generates an 8-bit digital phase signal 116.

The digital phase signal 116 operates as a control signal for the local oscillator generator 150, such that the output of the local oscillator generator 150 “locks” to a frequency equal to the product of a reference frequency 135 and a divider ratio produced as a result of the input phase signal 116. In addition, the output of the local oscillator generator 150 tracks the phase of the input phase signal 116 Therefore, the local oscillator generator 150 operates to up-convert the digital phase signal 116 to an RF phase signal 165, which is input to the multi-mode mixer 170 to produce a modulated RF signal 175. Since there is no envelope signal in GSM mode, the multi-mode mixer 170 merely passes the RF phase signal 165 to the power amplifier 180 as the modulated RF signal 175. The power amplifier 180 amplifies the modulated RF signal 175 to produce an amplified modulated RF signal.

When operating in EDGE mode, as the outgoing digital data 94 enters the digital processor 110, the control signal 105 instructs the digital processor 110 to perform pulse shaping and modulation on the outgoing digital data 94 to produce a variable envelope modulated digital signal. As described above, the EDGE standard employs 8-level Phase Shift Keying (PSK), which is a variable envelope modulation scheme. Therefore, the envelope path at the output of the digital processor 110 is activated in EDGE mode, and the digital processor 110 modulates the outgoing digital data 94 along both the envelope path and the phase path to generate digital envelope and digital phase signals 114 and 116, respectively.

For example, in one embodiment, the digital processor 110 includes an I/Q (Cartesian) digital modulator that performs the necessary pulse shaping, modulation, and interpolation filtering on the baseband data 94 to produce in-phase (I) and quadrature (Q) signals, followed by a polar converter that converts the in-phase and quadrature digital signals from Cartesian to polar form to produce an envelope (amplitude) signal 114 and a phase signal 116. In other embodiments, the digital processor 110 includes only an I/Q modulator, without a polar converter, and the resulting signals that are passed onto the envelope and phase paths are I/Q signals.

The I/Q digital modulator can include, for example, a symbol mapper and a pulse shaper. The symbol mapper maps incoming data bits in the baseband data 94 to a stream of digital symbols (e.g., PSK digital symbols), and the pulse shaper performs narrowband pulse shaping filtering on the digital symbols to produce the I and Q signals. The process of pulse shaping ensures that the transmitted RF signal is sufficiently band limited so as to not interfere excessively with adjacent RF channels. For example, the pulse shaper may include a square-root raised cosine (RRC) filter with a roll-off factor of 0.4. In embodiments including a polar converter, the polar converter converts the PSK in-phase and quadrature components produced by pulse shaper to a phase or frequency component, θ, represented by phase signal 116 and a magnitude (envelope) component, “r”, represented by envelope signal 114.

The digital envelope signal 114 is input to the high sample rate digital-to-analog converter (DAC) 122 to produce an analog envelope signal 126, followed by the LPF 132 to filter out any digital images and produce a filtered analog envelope signal 142 that is provided as an input signal 160 to the multi-mode mixer 170. As described above, the digital phase signal 116 operates as a control signal for the local oscillator generator 150. In EDGE mode, as in GSM mode, the output 165 of the local oscillator generator “locks” to a frequency equal to the product of the reference frequency 135 and a divider ratio produced as a result of the input digital phase signal 116. Therefore, the phase of the output 165 tracks the phase of the input phase signal 116, as desired. As such, the local oscillator generator 150 operates to up-convert the digital phase signal 116 to an RF phase signal 165. The RF phase signal 165 is input to the multi-mode mixer 170, where it is mixed with the filtered analog envelope signal 142 to produce a modulated RF signal 175. The power amplifier 180 amplifies the modulated RF signal 175 to produce an amplified modulated RF signal.

When in WCDMA mode, as the outgoing digital data 94 enters the digital processor 110, the control signal 105 instructs the digital processor 110 to perform pulse shaping and modulation on the outgoing digital data 94 to produce a variable envelope modulated digital signal, as in EDGE mode. As described above, the WCDMA standard also employs Phase Shift Keying (PSK), which is a variable envelope modulation scheme. However, instead of modulating the outgoing digital data 94 along both the envelope path and the phase path used for GSM/EDGE signals, in the example shown in FIG. 3, the digital processor 110 modulates the outgoing digital data 94 to produce a complex modulated digital signal 112. For example, as described above, the digital processor 110 can include an I/Q (Cartesian) digital modulator that performs the necessary pulse shaping, modulation, and interpolation filtering on the baseband data 94 to produce in-phase (I) and quadrature (Q) signals, which are output as the complex modulated digital signal 112.

The complex modulated digital signal 112 is input to the high sample rate DAC 120 to produce a complex modulated analog signal 125, followed by LPF 130 to produce a filtered complex modulated analog signal 140 that is provided as the input signal 160 to the multi-mode mixer 170. Typically, the I and Q components of the complex modulated digital signal 110 would be transmitted along separate paths, such that DAC 120 would include two DAC's, one for each signal component (I and Q), and LPF 130 would include two LPF's, one for each signal component (I and Q). The low pass filtered in-phase and quadrature signals would then be input to the multi-mode mixer 170.

In WCDMA mode, the envelope and phase paths at the output of the digital processor 110 are not activated to ensure that no dynamic signals are transmitted thereon. Thus, there is no phase signal 116 that is input to the local oscillator generator 150. As such, the output of the local oscillator generator 150 is a local oscillation signal 165 that tracks the phase of the reference signal 135. The local oscillation signal 165 is input to the multi-mode mixer 170 to up-convert the filtered complex modulated analog signal 140 from a baseband signal to a modulated RF signal 175. The power amplifier 180 amplifies the modulated RF signal 175 to produce an amplified modulated RF signal.

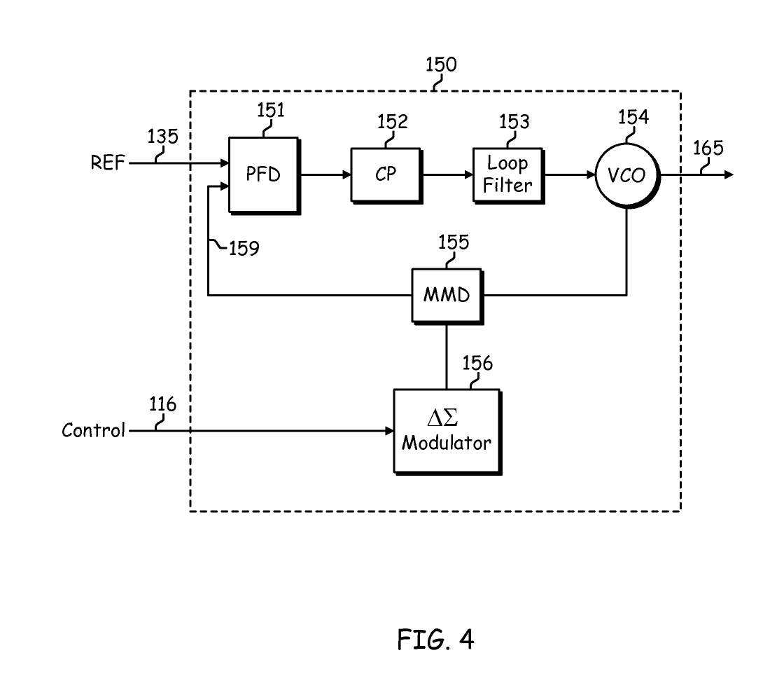

FIG. 4 is a schematic block diagram of an exemplary local oscillator generator 150 for use in the multi-mode transmitter architecture. The local oscillator generator 150 includes a phase and frequency detector (PFD) 151, a charge pump (CP) 152, a low pass loop filter 153, a voltage controlled oscillator (VCO) 154, a multi-modulus divider (MMD) 155 and a ΔΣ MMD controller 156. ΔΣ MMD controller 156 is coupled to receive the digital phase-modulated signal 116, and is operable to generate divider control signals to the MMD 155 based upon the digital phase-modulated signal 116. The MMD 155 is coupled to receive the divider control signals from the ΔΣ MMD controller 156 and is operable to produce a feedback signal 159 based on the divider control signals.

The PFD 151 is coupled to receive a reference signal 135 for comparing with the feedback signal 159 to produce an error signal indicative of a phase or frequency difference between the reference signal 135 and the feedback signal 159. The CP 152 produces current pulses based upon the error signal, and provides the current pulses to LPF 153. LPF 153 filters the current pulses to produce a control voltage that controls the oscillation of the VCO 154. In response to the control voltage, VCO 154 produces an oscillation that is output as the local oscillation signal 165 in WCDMA mode and the RF phase signal 165 in GSM/EDGE mode. In addition, the oscillation 165 produced by the VCO 154 is fed back to the MMD 155, which divides the oscillation 165 by a divider ratio to produce the feedback signal 159 that is provided to the PFD 151. As described above, MMD 155 sets the divider ratio based upon the divider control signal received from the ΔΣ MMD controller 156, and ΔΣ MMD controller 156 generates the divider control signal based upon the digital phase-modulated signal 116.

In a properly designed PLL, the feedback loop properties of the PLL results in the VCO output 165 “locking” to a frequency equal to the product of the reference frequency 135 and the divider ratio of the MMD 155. Thus, the closed loop tracking action causes the error signal at the output of the PFD 151 to approach zero, and therefore, the phase of the VCO output 165 tracks the phase of the digital phase-modulated signal 116, as desired.

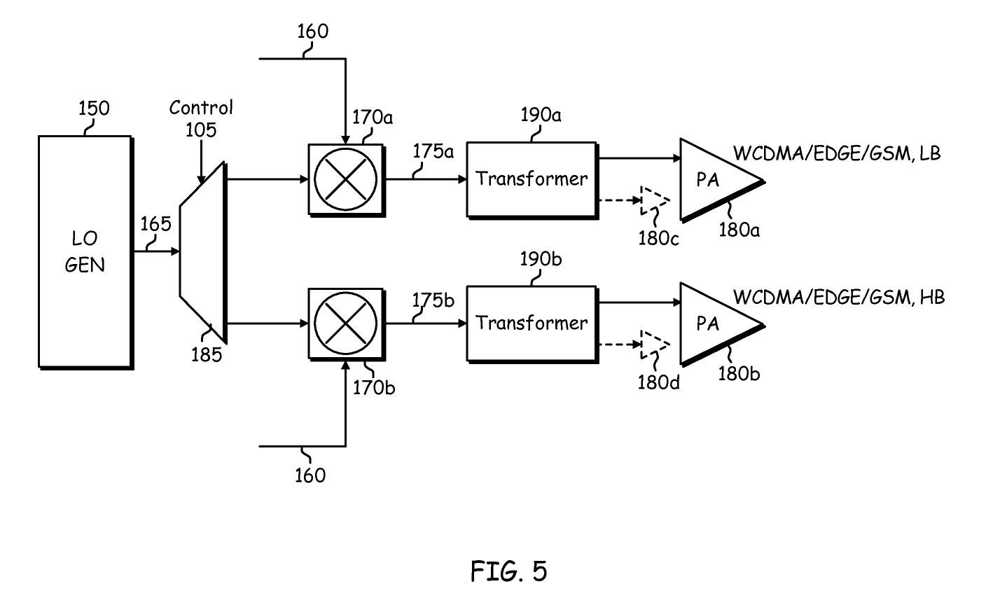

FIG. 5 is a schematic block diagram of a multi-mode transmitter architecture supporting high band and low band GSM/EDGE and WCDMA cellular telephony applications. In FIG. 5, the multi-mode mixer 170 of FIG. 3 is represented by two mixers 170a and 170b, each coupled to receive one of a high band WCDMA/GSM/EDGE signal and a low band WCDMA/GSM/EDGE signal. In particular, multi-mode mixer 170a is coupled to receive a low band WCDMA/GSM/EDGE signal, while multi-mode mixer 170b is coupled to receive a high band WCDMA/GSM/EDGE signal. For example, the frequency bands used for low band WCDMA/GSM/EDGE typically reside in the 800 MHz and 900 MHz ranges, while the frequency bands used for high band WCDMA/GSM/EDGE typically reside in the 1700 MHz, 1800 MHz, 1900 MHz and 2100 MHz ranges.

As shown in FIG. 5, the oscillation 165 output by the local oscillator generator 150 is input to switch 185, which selectively transmits the oscillation 165 to one of the multi-mode mixers 170a or 170b based on the control signal 105. In embodiments in which the oscillation 165 produced by the local oscillator generator 150 is a low band RF signal (i.e., a low band local oscillation signal or a low band RF phase signal, depending on the mode of operation), the control signal 105 sets the switch 185 to deliver the oscillation 165 to multi-mode mixer 170a. Mixer 170a mixes the oscillation 165 with an input signal 160a corresponding to a complex modulated signal or an envelope signal, again depending on the mode of operation.

Similarly, in embodiments in which the oscillation 165 produced by the local oscillator generator 150 is a high band RF signal (i.e., a high band local oscillation signal or a high band RF phase signal, depending on the mode of operation), the control signal 105 sets the switch 185 to deliver the oscillation 165 to multi-mode mixer 170b. Mixer 170b mixes the oscillation 165 with an input signal 160b corresponding to a complex modulated signal or an envelope signal, again depending on the mode of operation. Although not shown, it should be understood that input signal 160 is also selectively input to one of the multi-mode mixers 170a and 170b based on the chosen frequency band (low band or high band), using, for example, another switch.

The output 175a (i.e., low band modulated RF signal) of multi-mode mixer 170a is input to transformer 190a, which couples the modulated RF signal 175a to power amplifier 180a to produce an amplified low band modulated RF signal. The output 175b (i.e., high band modulated RF signal) of multi-mode mixer 170b is input to transformer 190b, which couples the high band modulated RF signal 175b to power amplifier 180b to produce an amplified low band modulated RF signal. In embodiments in which separate power amplifiers are used for WCDMA and GSM/EDGE, transformer 190a can couple the low band modulated RF signal 175a to power amplifier 180a for low band WCDMA transmissions and to power amplifier 180c for low band GSM/EDGE transmissions. Likewise, transformer 190b can couple the high band modulated RF signal 175b to power amplifier 180b for high band WCDMA transmissions and to power amplifier 180d for high band GSM/EDGE transmissions.

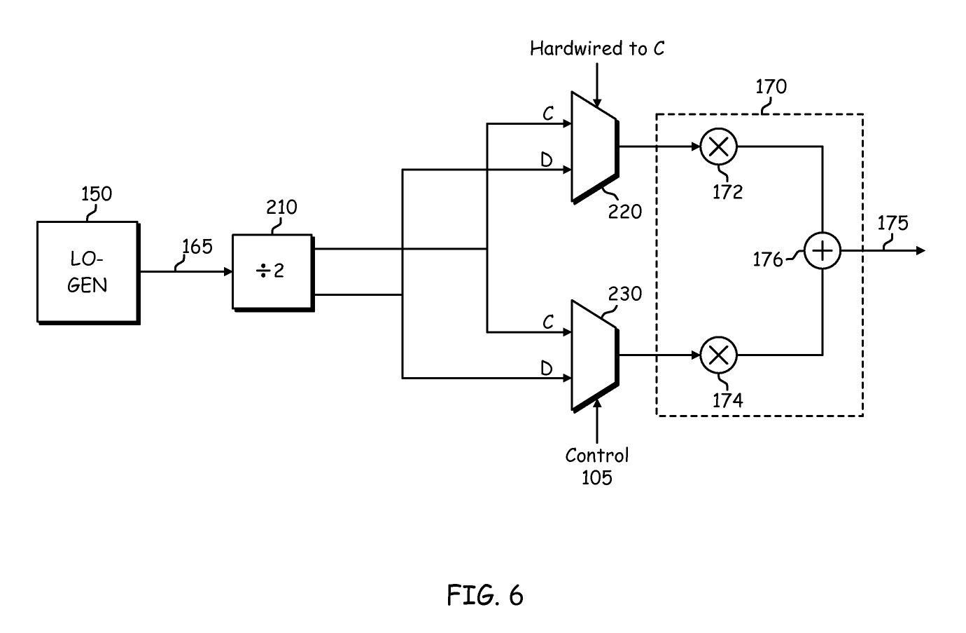

FIG. 6 is a schematic block diagram of a mixer 170 capable of operating in multiple modes. The multi-mode mixer 170 includes a first mixer 172, a second mixer 174 and a summation node 176. The input to first mixer 172 is coupled to the output of switch 220, while the input to the second mixer 174 is coupled to the output of switch 230. Switches 220 and 230 are coupled to receive the output from a divide by two block 210 that is coupled to receive the output from the local oscillator generator 150.

In an exemplary operation, the high-band or low-band oscillation 165 (e.g., a local oscillation signal or an RF phase signal) provided by the local oscillator generator is input to the divide by two block 210, where the oscillation 165 is divided into two signals, denoted C and D, that are 90 degrees out of phase with each other. For example, in GSM/EDGE mode, the output of the divide by two block 210 includes two signals C and D, as follows:

C=cos(ω_{c}t+φ(t))=in-phase (I) signal

D=sin(ω_{c}t+φ(t))=quadrature (Q) signal,

whereas in WCDMA mode, the output of the divide by two block 210 is:

C=cos(ω_{c}t)=in-phase (I) signal

D=sin(ω_{c}t)=quadrature (Q) signal.

The signals C and D are each input to both switches 220 and 230. Switch 220 is hard wired to select signal C and pass signal C to mixer 172. Switch 230 selects one of the signals C or D, depending on the value of the control signal 105. For example, in GSM/EDGE mode, the quadrature signal is not needed, and therefore, control signal 105 sets switch 230 to select signal C and pass signal C to mixer 174. In WCDMA mode, both the in-phase and quadrature signals are needed (LoI and LoQ), and therefore, control signal 105 sets switch 230 to select signal D and pass signal D to mixer 174.

Mixers 172 and 174 are coupled to mix the signals (C or D) received from switches 220 and 230 with the input signal 160 shown in FIG. 3. For example, in GSM/EDGE mode, mixers 172 and 174 each operate to mix the phase signal (corresponding to signal C) with the envelope signal 142 shown in FIG. 3. In WCDMA mode, mixer 172 operates to mix the in-phase local oscillation signal (LoI), corresponding to signal C, with the in-phase component of the complex modulated analog signal 140 shown in FIG. 3, while mixer 174 operates to mix the quadrature local oscillation signal (LoQ), corresponding to signal D, with the quadrature component of the complex modulated analog signal 140 shown in FIG. 3. The summation node 176 combines the mixer outputs to produce the modulated RF signal 175.

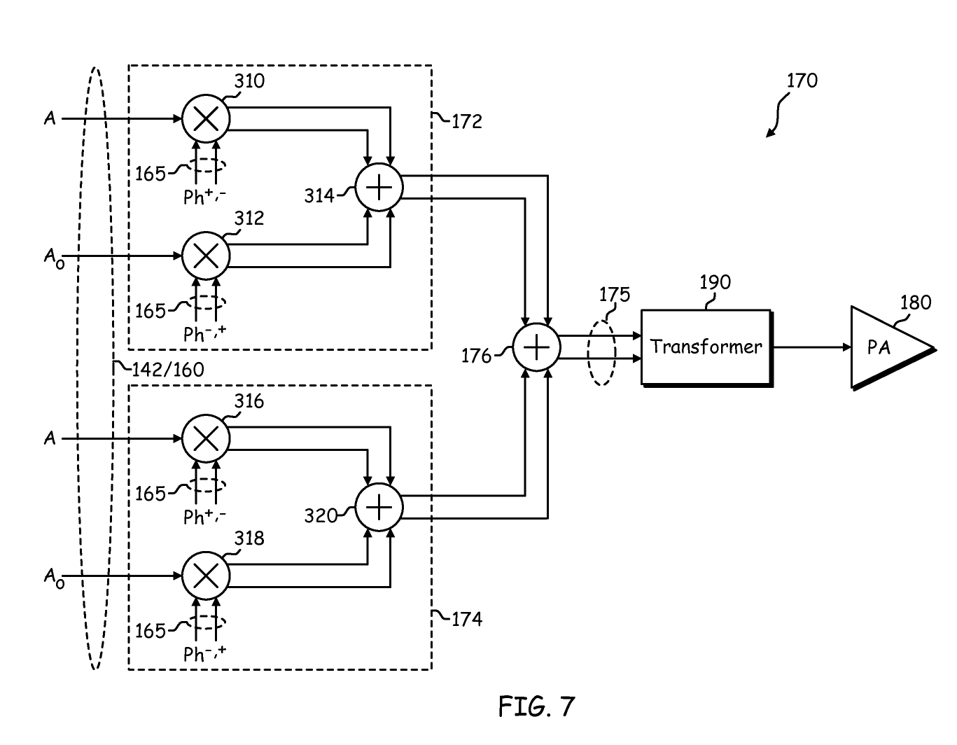

FIG. 7 is a schematic block diagram of a differential multi-mode mixer 170 operating in a GSM/EDGE mode. The differential mixer 170 includes mixers 172 and 174, as shown in FIG. 6. However, mixers 172 and 174 are differential, so that mixer 172 includes differential mixers 310 and 312 and summation node 314 and mixer 174 includes differential mixers 316 and 318 and summation node 320. As described above, in GSM/EDGE mode, the output of the local oscillation generator is an RF phase signal (Ph) 165, which is equal to cos(ω_{c}t+φ(t)). In FIG. 7, the RF phase signal (Ph) 165 includes differential signals Ph+,− and Ph−,+, which are input to the differential mixers 310, 312, 316 and 318. For example, as shown in FIG. 7, Ph+,− is input to mixers 310 and 316, while Ph−,+ is input to mixers 312 and 318.

In addition, mixers 310, 312, 316 and 318 are coupled to receive the analog envelope signal 142/160. The analog envelope signal can be represented as:

A=A(t)+A₀.

In GSM mode:

A(t)=constant

A₀=0.

As can be seen in FIG. 7, mixer 310 is coupled to receive signal A, mixer 312 is coupled to receive signal A₀, mixer 316 is coupled to receive signal A and mixer 318 is coupled to receive signal A₀. Thus, mixer 310 operates to mix A with Ph+,−, mixer 312 operates to mix A₀ with Ph−,+, mixer 316 operates to mix A with Ph+,− and mixer 318 operates to mix A₀ with Ph−,+.

The summation node 314 combines the outputs of mixers 312 and 314 to subtract out A₀, while summation node 320 combines the outputs of mixers 316 and 318 to subtract out A₀. The resulting signals are combined at summation node 176 to produce the modulated RF signal 175, which is provided to transformer 190. Transformer 190 couples the modulated RF signal 175 to power amplifier 180 to produce an amplified low band modulated RF signal.

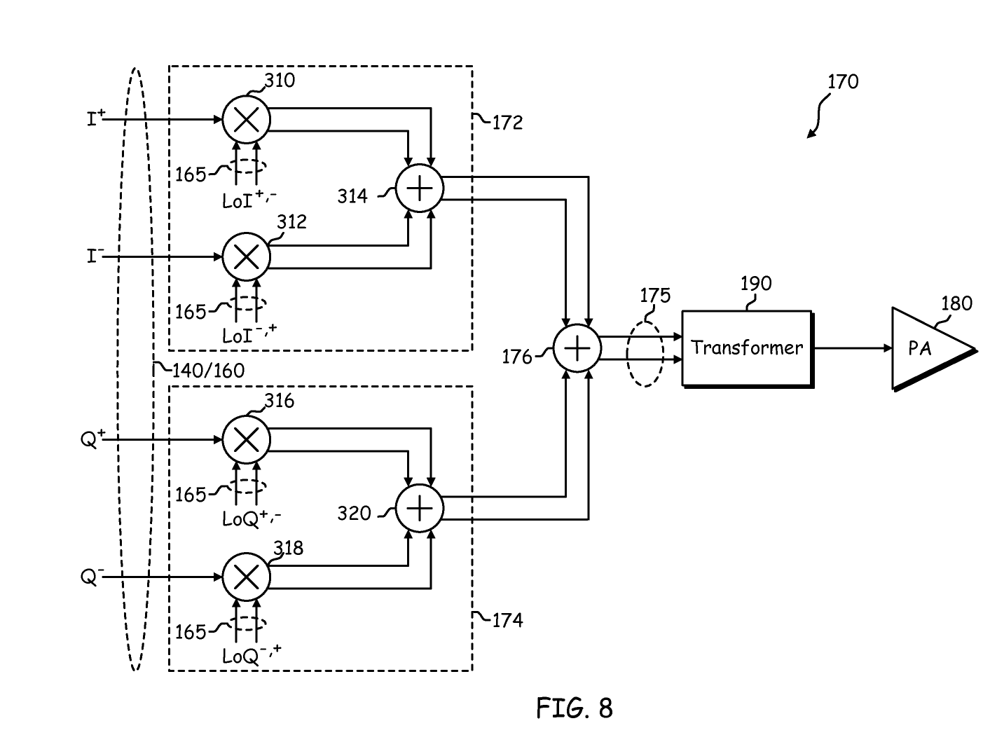

FIG. 8 is a schematic block diagram of the differential multi-mode mixer 170 operating in a WCDMA mode. As described above, in WCDMA mode, the output of the local oscillation generator is a local oscillation signal 165 (LoI and LoQ). In FIG. 7, the local oscillation signal 165 includes differential signals LoI+,−, LoI−,+, LoQ+,− and LoQ−,+, which are input to the differential mixers 310, 312, 316 and 318. For example, as shown in FIG. 7, LoI+,− is input to mixer 310, LoI−,+ is input to mixer 312, LoQ+,− is input to mixer 316 and LoQ−,+ is input to mixer 318.

In addition, mixers 310, 312, 316 and 318 are coupled to receive the complex modulated analog signal 140/160. The complex modulated analog signal includes an in-phase component (I) and a quadrature component (Q), both of which are differential signals. In particular, mixer 310 is coupled to receive I+, mixer 312 is coupled to receive I−, mixer 316 is coupled to receive Q+ and mixer 318 is coupled to receive Q−. Thus, mixer 310 operates to mix I+ with LoI+,−, mixer 312 operates to mix I− with LoI−,+, mixer 316 operates to mix Q+ with LoQ+,− and mixer 318 operates to mix Q− with LoQ−,+.

The summation node 314 combines the outputs of mixers 312 and 314, while summation node 320 combines the outputs of mixers 316 and 318. The resulting signals are combined at summation node 176 to produce the modulated RF signal 175, which is provided to transformer 190. Transformer 190 couples the modulated RF signal 175 to power amplifier 180 to produce an amplified low band modulated RF signal.

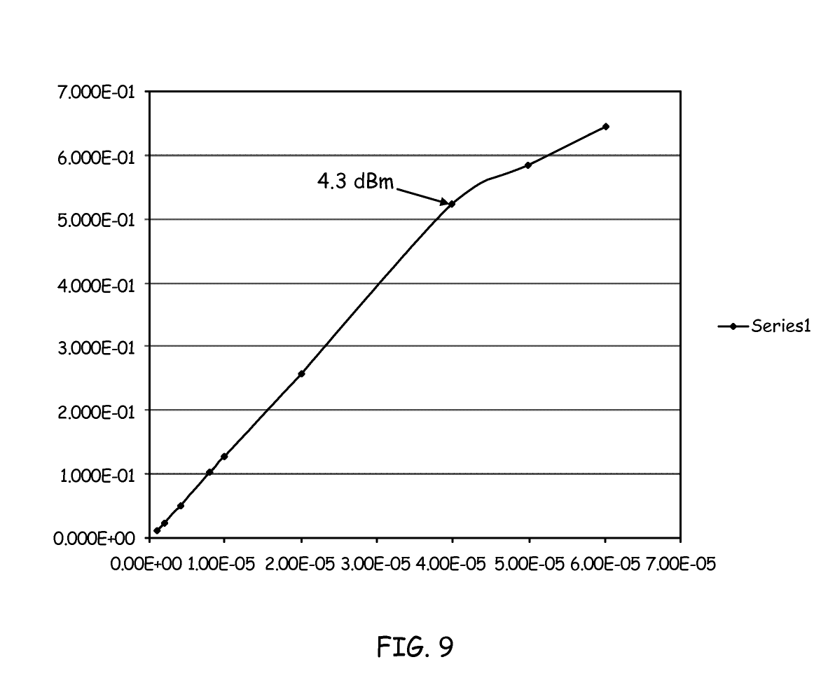

FIG. 9 illustrates the non-linearity of each I-Q multi-mode mixer in the current limited mode. In FIG. 9, it is assumed that each I-Q multi-mode mixer is consuming 20 mA of current. In variable envelope modulation modes, the power is varying over time. Therefore, the I-Q multi-mode mixers need to be able to handle high power in order to drive the power amplifiers without the need for a separate power amplifier driver in both WCDMA and GSM/EDGE modes. However, in the model shown in FIG. 9, in order to maintain linearity in the I-Q multi-mode mixers, the maximum power should be below 4.3 dBm.

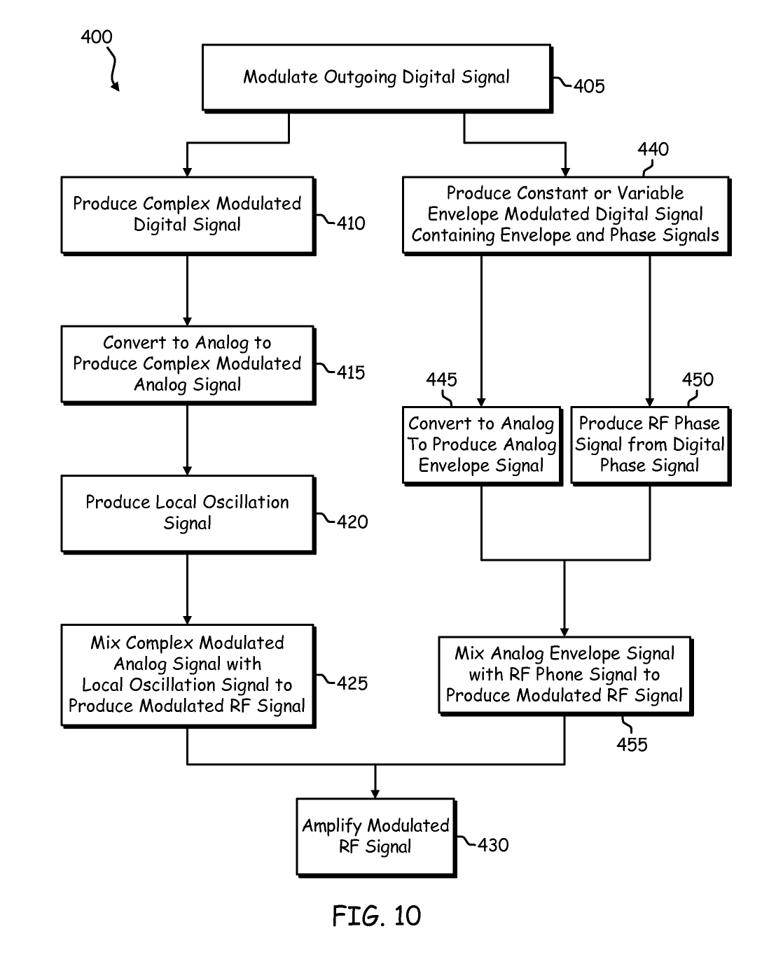

FIG. 10 is a flow chart illustrating one method 400 of the present invention for operating in different modulation modes. A digital processor within an RF transmitter receives an outgoing digital signal including a plurality of data bits for transmission and modulates an outgoing digital signal based on a control signal (modulation control signal) indicating a type of modulation (e.g., PSK or GMSK) to be used at block 405. The transmission data bits are typically received from a baseband processor, and represent the baseband digital data to be transmitted to a mobile host, such as hosts 18-23 of FIG. 1. The selected modulation produces either a complex modulated digital signal at block 410 or a constant/variable envelope modulated digital signal at block 440. Both the constant envelope modulated digital signal and the variable envelope modulated digital signal include an envelope signal (which is constant for the constant envelope modulated digital signal) and a phase signal.

In embodiments in which a complex modulated digital signal is produced at block 410, the method converts the complex modulated digital signal to analog to produce a complex modulated analog signal at block 415. Thereafter, a high-band or low-band RF local oscillation signal is produced at block 420, and at block 425, the complex modulated analog signal is mixed with the local oscillation signal to up-convert the complex modulated analog signal and produce a modulated RF signal. At block 430, the modulated RF signal is amplified to produce an amplified modulated RF signal.

In embodiments in which a digital envelope signal and digital phase signal are produced at block 440, the method converts the digital envelope signal to analog to produce an analog envelope signal at block 445. In addition, at block 450, the digital phase signal is up-converted to an RF signal. The RF phase signal is mixed with the analog envelope signal at block 455 to produce a modulated RF signal. Finally, at block 430, the modulated RF signal is amplified to produce an amplified modulated RF signal.

As may be used herein, the term(s) “coupled to” and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

1. An RF transmitter for operating in different modulation modes, comprising:
a digital processor coupled to receive a control signal and operable to modulate an outgoing digital signal based on the control signal to produce a complex modulated digital signal in a first modulation mode and one of a constant envelope modulated digital signal and a variable envelope modulated digital signal in a second modulation mode, the constant envelope modulated digital signal and the variable envelope modulated digital signal each include an envelope signal and a phase signal, wherein the envelope signal of the constant envelope modulated digital signal is a constant envelope signal and the envelope signal of the variable envelope modulated digital signal is a variable envelope signal;
digital-to-analog converters for converting the complex modulated digital signal and the envelope signal, respectively, from digital signals to analog signals to produce a complex modulated analog signal in the first modulation mode and an analog envelope signal in the second modulation mode;
a local oscillation generator operable to produce a local oscillation signal in the first modulation mode and coupled to receive the digital phase signal and operable to up-convert the digital phase signal to an RF phase signal in the second modulation mode;
a mixer coupled to receive the complex modulated analog signal and the local oscillation signal and operable to up-convert the complex modulated analog signal to a modulated RF signal in the first modulation mode and coupled to receive the RF phase signal and the analog envelope signal and operable to produce the modulated RF signal based on the RF phase signal and the analog envelope signal in the second modulation mode; and
a power amplifier coupled to receive the modulated RF signal and operable to produce an amplified modulated RF signal.

2. The RF transmitter of claim 1, wherein the second modulation mode indicates one of a constant envelope modulation mode or a variable envelope modulation mode, and wherein the digital processor is operable to produce 8-level Phase Shift Keying (PSK) symbols for use in producing the variable envelope modulated digital signal in the variable envelope modulation mode and to produce Gaussian Minimum Shift Keying (GMSK) symbols for use in producing the constant envelope modulated digital signal in the constant envelope modulation mode.

3. The RF transmitter of claim 1, wherein the digital processor is operable to produce 4-level Phase Shift Keying (PSK) symbols for use in producing the complex modulated digital signal in the first modulation mode.

4. The RF transmitter of claim 1, wherein the mixer operates to drive the power amplifier.

5. The RF transmitter of claim 1, wherein the mixer includes first and second mixers, each associated with one of a high frequency band or a low frequency band and the power amplifier includes first and second power amplifiers, each coupled to one of the first and second mixers, the control signal selecting one of the first and second mixers.

6. The RF transmitter of claim 1, wherein the complex modulated analog signal includes an in-phase modulated analog signal and a quadrature modulated analog signal and the local oscillation signal includes an in-phase local oscillation signal and a quadrature local oscillation signal.

7. The RF transmitter of claim 6, wherein the mixer includes a first mixer and a second mixer, the first mixer coupled to receive the in-phase local oscillation signal and the in-phase modulated analog signal and operable to produce a modulated in-phase RF signal and the second mixer coupled to receive the quadrature local oscillation signal and the quadrature modulated analog signal to produce a modulated quadrature RF signal in the first modulation mode.

8. The RF transmitter of claim 7, further comprising:
a summation node coupled to receive the modulated in-phase RF signal and the modulated quadrature RF signal in the first modulation mode and operable to produce the modulated RF signal.

9. The RF transmitter of claim 8, wherein:
the first mixer and the second mixer are each coupled to receive a respective portion of the RF phase signal and a respective portion the analog envelope signal and operable to produce first and second portions of the modulated RF signal in the second modulation mode; and
the summation node is coupled to receive the first and second portions of the modulated RF signal and operable to produce the modulated RF signal in the second modulation mode.

10. The RF transmitter of claim 9, wherein the first and second mixers are differential mixers.

11. The RF transmitter of claim 9, further comprising:
a divide-by-two block coupled to receive the local oscillation signal and operable to produce the in-phase local oscillation signal and the quadrature phase local oscillation signal in the first modulation mode and coupled to receive the RF phase signal and operable to produce an in-phase RF phase signal and a quadrature RF phase signal in the second modulation mode; and
first and second switches, each coupled to receive both the in-phase local oscillation signal and the quadrature phase local oscillation signal in the first modulation mode and both the in-phase RF phase signal and the quadrature RF phase signal in the second modulation mode, the first switch selecting the in-phase local oscillation signal for output to the first mixer in the first modulation mode and the in-phase RF phase signal for output to the first mixer in the second modulation mode, the second switch selecting the quadrature phase local oscillation signal for output to the second mixer in the first modulation mode and the in-phase RF phase signal for output to the second mixer in the second modulation mode based on the control signal.

12. A method in an RF transmitter for operating in different modulation modes, comprising:
modulating an outgoing digital signal to produce a complex modulated digital signal in a first modulation mode and one of a constant envelope modulated digital signal and a variable envelope modulated digital signal in a second modulation mode based upon a control signal, the constant envelope modulated digital signal and the variable envelope modulated digital signal each include an envelope signal and a phase signal, wherein the envelope signal of the constant envelope modulated digital signal is a constant envelope signal and the envelope signal of the variable envelope modulated digital signal is a variable envelope signal;
converting the complex modulated digital signal and the envelope signal, respectively, from digital signals to analog signals to produce a complex modulated analog signal in the first modulation mode and an analog envelope signal in the second modulation mode;
producing a local oscillation signal in the first modulation mode and an RF phase signal based upon the digital phase signal in the second modulation mode;
mixing, in the first modulation mode, the complex modulated analog signal and the local oscillation signal to produce a modulated RF signal and, in the second modulation mode, the RF phase signal and the analog envelope signal to produce the modulated RF signal; and
amplifying the modulated RF signal to produce an amplified modulated RF signal.

13. The method of claim 12, wherein the second modulation mode indicates one of a constant envelope modulation mode or a variable envelope modulation mode and wherein the modulating the outgoing digital signal further comprises:
producing 8-level Phase Shift Keying (PSK) symbols for use in producing the variable envelope modulated digital signal in the variable envelope modulation mode; and
producing Gaussian Minimum Shift Keying (GMSK) symbols for use in producing the constant envelope modulated digital signal in the constant envelope modulation mode.

14. The method of claim 12, wherein the modulating the outgoing digital signal further comprises:
producing 4-level Phase Shift Keying (PSK) symbols for use in producing the complex modulated digital signal in the first modulation mode.

15. The method of claim 12, further comprising:
driving the power amplifier using the mixer.

16. The method of claim 12, wherein the complex modulated analog signal includes an in-phase modulated analog signal and a quadrature modulated analog signal and the local oscillation signal includes an in-phase local oscillation signal and a quadrature local oscillation signal, wherein the mixer includes a first mixer and a second mixer, and wherein the mixing in the first modulation mode further comprises:
mixing the in-phase local oscillation signal and the in-phase modulated analog signal at the first mixer to produce a modulated in-phase RF signal in the first modulation mode; and
mixing the quadrature local oscillation signal and the quadrature modulated analog signal at the second mixer to produce a modulated quadrature RF signal in the first modulation mode.

17. The method of claim 16, further comprising:
performing a summation operation on the modulated in-phase RF signal and the modulated quadrature RF signal in the first modulation mode to produce the modulated RF signal.

18. The method of claim 17, wherein the mixing in the second modulation mode further comprises:
mixing a respective portion of the RF phase signal and a respective portion the analog envelope signal at each of the first and second mixers to produce first and second portions of the modulated RF signal, respectively, in the second modulation mode; and
performing a summation operation on the first and second portions of the modulated RF signal to produce the modulated RF signal in the second modulation mode.

19. The method of claim 18, wherein the first and second mixers are differential mixers.

20. The method of claim 18, further comprising:
producing the in-phase local oscillation signal and the quadrature phase local oscillation signal from the local oscillation signal in the first modulation mode and an in-phase RF phase signal and a quadrature RF phase signal from the RF phase signal in the second modulation mode;
providing both the in-phase local oscillation signal and the quadrature phase local oscillation signal in the first modulation mode and both the in-phase RF phase signal and the quadrature RF phase signal in the second modulation mode to first and second switches;
selecting, by the first switch, the in-phase local oscillation signal for output to the first mixer in the first modulation mode and the in-phase RF phase signal for output to the first mixer in the second modulation mode; and
selecting, by the second switch, the quadrature phase local oscillation signal for output to the second mixer in the first modulation mode and the in-phase RF phase signal for output to the second mixer in the second modulation mode.
